(19) United States
(12) Patent Application Publication
(10) Pub. No.: US 2016/0232551 A1
(43) Pub. Date: Aug. 11, 2016

(54) PARTNER PROGRAM PARTICIPATION SYSTEM AND METHOD

(71) Applicant: KRAFT GROUP LLC, Foxborough, MA (US)

(72) Inventors: Jonathan A. Kraft, Foxborough, MA (US); Patricia A. Curley, Belmont, MA (US)

(21) Appl. No.: 14/614,918

(22) Filed: Feb. 5, 2015

(51) Int. Cl. G06Q 30/02; G06F 17/30; H04L 29/08

(52) U.S. Cl. CPC G06Q 30/0214; H04L 67/06; G06F 17/30867; G06Q 30/0226

(57) ABSTRACT

According to one aspect, embodiments of the invention provide a method for providing partner program participation in a first loyalty program of an organization, the method comprising receiving, with a partner program participation module operated on a server of the organization, an activity file from a partner organization, the activity file including information related to a qualifying action taken by a customer with respect to a second loyalty program of the partner organization, and updating in a database of the organization, with the partner program participation module, a first customer record associated with the first loyalty program of the organization based on the information to included in the activity file related to the qualifying action taken by the customer with respect to the second loyalty program of the partner organization.

### BACKGROUND OF THE DISCLOSURE

1. Field of the Invention

Aspects of the present invention relate to a system and method for partner program participation in a loyalty program of an organization.

2. Discussion of Related Art

A loyalty program is a marketing program designed to enhance brand loyalty by to cultivating an ongoing relationship between a marketer and his customer. Successful loyalty programs encourage the consumer to buy frequently, to increase the amount spent each time, and to concentrate all or most of their related purchases on that brand by offering perks or rewards for membership in the program and/or for qualifying actions (e.g., purchases) made by the customer.

### SUMMARY

Embodiments described herein provide a system and method for partner program participation in a loyalty program of a main organization. In one embodiment described herein, a partner program participation module of the main organization receives activity files from a partner organization. The activity files include information related to qualifying actions taken by customers with respect to a loyalty program of the partner organization. The partner program participation module of the main organization updates customer loyalty records (e.g., provides rewards) in the main organization based on the information included in the activity files related to the qualifying actions taken by the customers with respect to the loyalty program of the partner organization.

In one embodiment, the main organization is a sports organization (e.g., a professional sports team) having a relatively large group of season ticket holders or members. The sports organization may partner with other external organizations (i.e., partner organizations), having their own products/services and having their own loyalty programs, for the purposes of cooperatively marketing to particular demographics where the cooperative marking is intended to increase sales/income at both the sports organization and the partner organizations. In some embodiments, the partner organizations are retailers, restaurants, other venues, etc. The partner organizations may be any type of organization that operates a loyalty program.

As season ticket holders/members of the sports organization take qualifying actions (e.g., make purchases) with the loyalty programs of the partner organizations, the partner organizations provide information to the sports organization regarding the qualifying actions of the season ticket holders/members. Upon matching the season ticket holder/member information received from the partner organizations with its own season ticket holder/member information, the sports organization provides rewards (e.g., credit) to each season ticket holder/member that also took a qualifying action with a partner organization. The sports organization may transmit the credit information to a ticket management service (e.g., Ticketmaster of Charleston, W.Va.) to update the record of each corresponding season to ticket holder/member with the appropriate credit. The credit may be applied to a balance owed by the season ticket holder/member or to future purchased tickets. To this end, according to various embodiments, systems and interfaces may be provided that allow a season ticket holder/member to view their qualifying actions/activities, any corresponding rewards or credits, and apply a credit to their season ticket holder/member account.

By providing loyalty program activity information from a partner organization to the main organization and automatically matching the activity information to a member of the main organization's loyalty program, the main organization can provide a reward to the customer for actions taken outside the main organization. This may incentivize a loyalty member of the main organization to perform a qualifying action with a partner organization that they might not otherwise have taken, as they may receive a reward from both the partner and main organizations for the qualifying action. The main organization can monetize the additional business that is driven towards the partner organization by invoicing the partner organization based on rewards awarded in the main organization for the qualifying action at the partner organization.

Also, by utilizing the “one-way” transfer of information (i.e., only the transfer of information from the partner organization to the main organization (e.g., via an FTP client)) to match the qualifying action of a customer to the loyalty program of the main organization, access to the systems of the main organization by the partner organization may be limited and the transfer of potentially sensitive information from the main organization to the partner organization can be avoided. In addition, by analyzing the loyalty program activity information from the partner organization, the main organization can gain valuable marketing insight into the purchasing behaviors of its loyalty members.

One aspect of the present invention is directed to a system for partner program participation in a first loyalty program of an organization, the system comprising a network interface configured to be coupled to a communication network, a database configured to store a plurality of customer records associated with the first loyalty program of the organization, and a partner program participation module coupled to the network interface and the database and configured to communicate with a server of a partner organization via the network interface and the communication network, wherein the partner program participation module is further configured to receive an activity file from the server of the partner organization, the activity file including information related to a qualifying action taken by a customer with respect to a second loyalty program of the partner organization, and update, in the database, a first customer record associated with the first loyalty program of the to organization based on the information included in the activity file related to the qualifying action taken by the customer with respect to the second loyalty program of the partner organization.

According to one embodiment, the system further comprises a file server coupled to the partner program participation module and the network interface and configured to receive the activity file from the server of the partner organization and provide the activity file to the partner program participation module. In one embodiment, the file server utilizes the File Transfer Protocol (FTP) to communicate with the server of the partner organization

According to another embodiment, the partner program participation module comprises a matching engine coupled to the database, wherein the matching engine is configured to cross-reference the information in the activity file with the plurality of customer records stored in the database to identify the first customer record. In one embodiment, the partner program participation module comprises a reward engine coupled to the database, wherein the reward engine is configured to update, in the database, the first customer record associated with the first loyalty program of the organization based on the information included in the activity file. In one embodiment, the reward engine is further configured to update the first customer record with a reward based on the information included in the activity file related to the qualifying action taken by the customer with respect to the second loyalty program of the partner organization. In another embodiment, the partner program participation module is further configured to communicate with an external vendor via the communication network and transmit a record update request to the vendor based on the reward.

According to one embodiment, the reward engine is further configured to insert the information included in the activity file into the first customer record. In another embodiment, the partner program participation module is further configured to transmit a report back to the partner organization in response to the reward engine updating the first customer record. In one embodiment, the report is one of a confirmation message and an invoice. In another embodiment, the partner program participation module is further configured to transmit the report via an external messaging service. According to another embodiment, the partner program participation module is further configured to identify the partner organization based on information included in the activity file, retrieve, from the database, at least one business rule specific to the partner organization, and update the first customer record based on the at least one business rule.

According to one embodiment, the organization is a sports organization, the first to loyalty program of the sports organization is a season ticket member program, and the partner program participation module is further configured to update the first customer record associated with the season ticket member program with a credit based on the information included in the activity file. In one embodiment, the partner program participation module is further configured to communicate with an external ticket management system via the communication network and transmit a record update request to the external ticket management system based on the credit.

Another aspect of the present invention is directed to a method for providing partner program participation in a first loyalty program of an organization, the method comprising receiving, with a partner program participation module operated on a server of the organization, an activity file from a loyalty program module operated on a server of a partner organization, the activity file including information related to a qualifying action taken by a customer with respect to a second loyalty program of the partner organization, and updating in a database of the organization, with the partner program participation module, a first customer record associated with the first loyalty program of the organization based on the information included in the activity file related to the qualifying action taken by the customer with respect to the second loyalty program of the partner organization.

According to one embodiment, the method further comprises generating, with the loyalty program module operated on the server of the partner organization, the activity file based on the qualifying action taken by the customer with respect to the second loyalty program of the partner organization. In another embodiment, the method further comprises determining, with the loyalty program module, whether the customer is also a member of the first loyalty program of the organization, and in response to a determination that the customer is also a member of the first loyalty program of the organization, providing the activity file to the partner program participation module operated on the server of the organization. In one embodiment, determining comprises referencing a loyalty program record in a database of the partner organization to determine if the record includes an indication of participation in the first loyalty program of the organization.

According to another embodiment, the method further comprises cross-referencing, with a matching engine operated by the partner program participation module, information included in the activity file with a plurality of customer loyalty program records stored in the database of the organization to identify the first customer record. In one embodiment, generating the activity file comprises including a unique identifier associated with the first loyalty program of the organization in the activity file and cross-referencing includes to matching the unique identifier in the activity file with the plurality of customer loyalty program records stored in the database of the organization to identify the first customer record.

According to one embodiment, updating comprises updating the first customer record to include a reward based on the information included in the activity file related to the qualifying action taken by the customer with respect to the second loyalty program of the partner organization. In another embodiment, the method further comprises providing a record update request to an external vendor based on the reward. In one embodiment, the method further comprises providing, with the partner program participation module, a report back to the partner organization in response to updating the first customer record. In another embodiment, providing a report back to the partner organization comprises one of providing an invoice to the partner organization and providing a confirmation message to the partner organization.

According to another embodiment, the method further comprises identifying the partner organization based on information included in the activity file, and retrieving, from the database of the organization, at least one business rule specific to the partner organization, wherein updating the first customer record includes updating the first customer record based on the at least one business rule.

According to one embodiment, the organization is a sports organization and the first loyalty program of the sports organization is a season ticket member program, and updating includes updating the first customer record associate with the season ticket member program with a credit based on the information included in the activity file. In one embodiment, the method further comprises transmitting a record update request to an external ticket management system based on the credit.

At least one aspect of the present invention is directed to a non-transitory computer-readable medium encoded with instructions for execution on a distributed computer system of an organization, the instructions when executed, performing a method comprising acts of receiving, with a partner program participation module operated on a server of the organization, an activity file from a loyalty program module operated on a server of a partner organization, the activity file including information related to a qualifying action taken by a customer with respect to a second loyalty program of the partner organization, and updating in a database of the organization, with the partner program participation module, a first customer record associated with the first loyalty program of the organization based on the information included in the activity file related to the qualifying action taken by the customer with respect to the second loyalty program of the partner organization.

### BRIEF DESCRIPTION OF DRAWINGS

The accompanying drawings are not intended to be drawn to scale. In the drawings, each identical or nearly identical component that is illustrated in various FIGs. is represented by a like numeral. For purposes of clarity, not every component may be labeled in every drawing. In the drawings:

FIG. 1 is a block diagram illustrating a system for partner program participation in an loyalty marketing program of an organization in accordance with at least one embodiment described herein;

FIG. 2 is a flow chart illustrating a process for partner program participation in an loyalty marketing program of an organization in accordance with at least one embodiment described herein;

FIG. 3 is a process flow diagram illustrating operation of a partner program participation system in accordance with at least one embodiment described herein;

FIG. 4 is a block diagram of a computer system upon which various embodiments of the invention may be implemented; and

FIG. 5 is a block diagram of a computer data storage system with which various embodiments of the invention may be practiced.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any to embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

As discussed above, loyalty programs are commonly used by organizations to enhance brand loyalty and to drive customers to take actions that benefit the organization (e.g., such as to make qualifying purchases). In a typical loyalty program, an organization provides a benefit (e.g., credits, money, points, discounts, etc.) to a customer in exchange for the customer taking a qualifying action (e.g., making a qualified purchase, signing up for an email list, signing up for a rewards program, etc.). For example, in the loyalty program of a supermarket, the supermarket may credit points to a customer in exchange for the customer spending a predetermined amount of money or purchasing a certain product at the supermarket. In another example, the loyalty program of a sports organization or venue may provide credit to a customer in exchange for the customer making concessions or apparel purchases from the sports organization or at the venue. Points or credit accrued by a customer in a loyalty marketing program may typically be exchanged later for a discount or some other benefit.

While conventional loyalty programs are known to be successful in generating brand loyalty and business by rewarding customers for actions taken within an organization, they can be limited in that the qualified behavior that results in a benefit being provided to the customer may be limited to within the organization itself. Benefits are typically not provided in the organization for activities performed outside the organization (e.g., with another organizations loyalty program). Accordingly, embodiments described herein provide a system and method for partner program participation in a loyalty program of an organization. By connecting the loyalty program of a main organization with another partner's loyalty program, benefits may be provided in the main organization for activities performed by the customer with the partner's loyalty program. Such a connection may be monetized by the main organization (e.g., by charging the partner organization for business generated at the partner as a result of the connection with the loyalty program of the main organization) and may also provide the organization with valuable market data in reference to the organization's customers. Further, a partner organization may benefit from cooperative marketing with the main organization as loyalty awards gained from the main organization may cause consumers to perform certain activities in the partner's loyalty program.

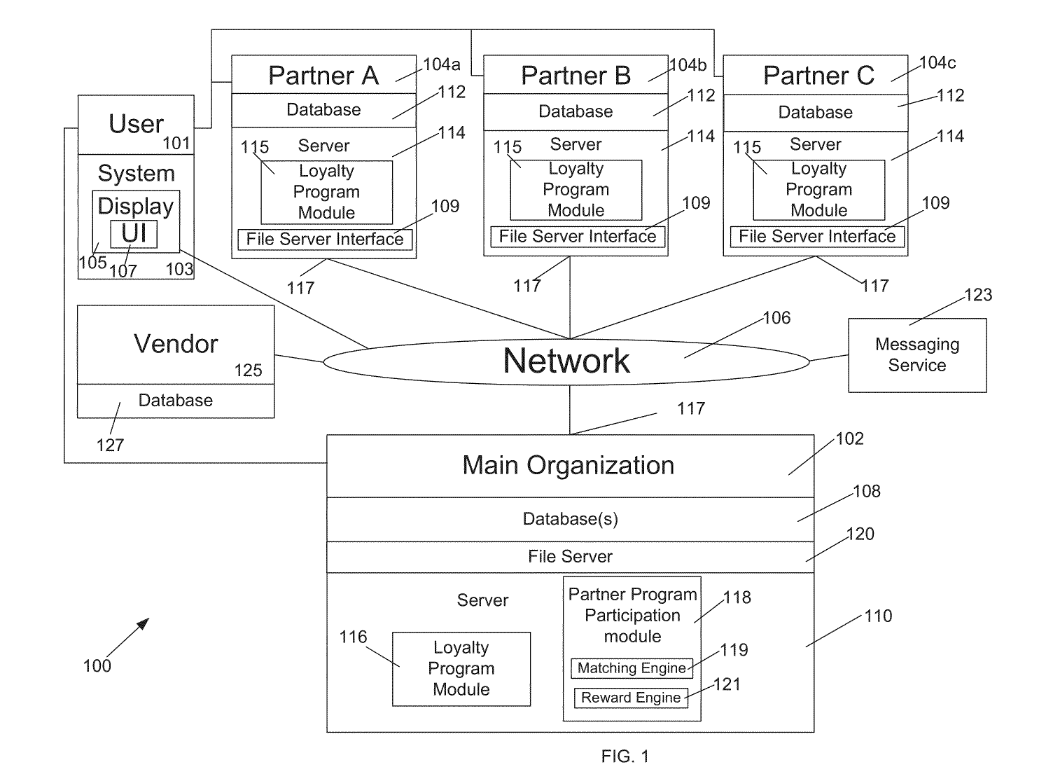

FIG. 1 illustrates one embodiment of a system 100 for partner program participation in a loyalty marketing program of an organization in accordance with at least one embodiment described herein. The system 100 includes the main organization 102, a group of partner organizations 104(a-c), and a network 106. The main organization operates a main database 108, a main server 110, and a file server 120. The main server 110 operates a loyalty program module 116 and a partner program participation module 118. Each partner organization 104(a-c) operates a partner database 114 and a partner server 112. Each partner server 112 operates a partner loyalty program module 115 and a file server interface 109.

The main server 110 operated by the main organization 102 is configured to communicate with other systems operated by the main organization 102 (e.g., Point of Sale (POS) systems, ticketing systems, administration systems, etc.) along with the main database 108 and the file server 120. According to one embodiment, the main server 110 communicates with the different main organization systems, the database 108, and the file server 120 via a Local Area Network (LAN). The main server 110 may communicate with the different systems wirelessly or via a hardwired connection. The loyalty program module 116 and the partner program participation module 118 are also configured to communicate with each other.

Each partner server 114 operated by a partner organization 104(a-c) is configured to communicate with other systems operated by its partner organization 104(a-c) (e.g., Point of Sale (POS) systems, ticketing systems, administration systems, etc.) along with its corresponding partner database 112. According to one embodiment, each partner server 114 communicates with the different partner organization systems and the corresponding database via a Local Area Network (LAN). Each partner server 114 may communicate with the different store systems wirelessly or via a hardwired connection. Each partner server 114 is also configured to communicate with the file server 120 and/or the server 110 operated by the main organization 102 via the network 106 and the network interfaces 117. The loyalty to program module 115 is also configured to communicate with the file server interface 109.

The partner program participation module 118 operated by the main server 110 of the main organization 102 operates a matching engine 119 and a reward engine 121. The partner program participation module 118 is configured to communicate with the loyalty program module 115 operated by the partner server 114 of each partner organization 104(a-c). The partner program participation module 118 communicates with the partner servers 114 via the network 106 and network interfaces 117 at the main server 110 and the partner servers 114. According to one embodiment, the network 106 is the Internet; however, in other embodiments, the network 106 may be some other type of Wide Area Network (WAN) or group of networks. Also, it should be appreciated that one or more functions as described herein may be performed by one or more services distributed among one or more systems.

As a user 101 (e.g., a customer), who is a member of the main organization's loyalty program, interacts (e.g., makes a purchase or some other qualifying action) with the main organization, the loyalty program module 116 of the main organization 102 provides an appropriate reward (e.g., points, credit, etc) to the customer for interacting with the main organization. The loyalty program module 116 may update the customer's loyalty program record in the main database 108 to reflect the reward. The customer may also interact with the loyalty program module 116 of the main organization 102 (e.g., via an interface operated by the customer that is in communication with the server 110 via the network 106) to redeem any rewards.

As a customer 101, who is a member of a partner organization's (e.g., Partner A 104a) loyalty program, interacts (e.g., makes a purchase or some other qualifying action) with the partner organization 104a, the loyalty program module 115 of the partner organization 104a provides an appropriate reward (e.g., points, credit, etc) to the customer for interacting with the partner organization. The loyalty program module 115 may update the customer's loyalty program record in the corresponding partner database 112 to reflect the reward. If the customer is also a member of the loyalty program of the main organization 102, the loyalty program module 115 of the partner organization 104a transmits information regarding the qualifying activity of the customer (e.g., the transaction information) to the partner program participation module 118 in the main server 110.

The partner program participation module 118 analyzes the information received from the loyalty program module 115 regarding the qualifying activity by the customer at the partner organization 104a and, based on the activity taken by the customer at the partner organization 104a, may also provide a reward to the customer at the main organization 102.

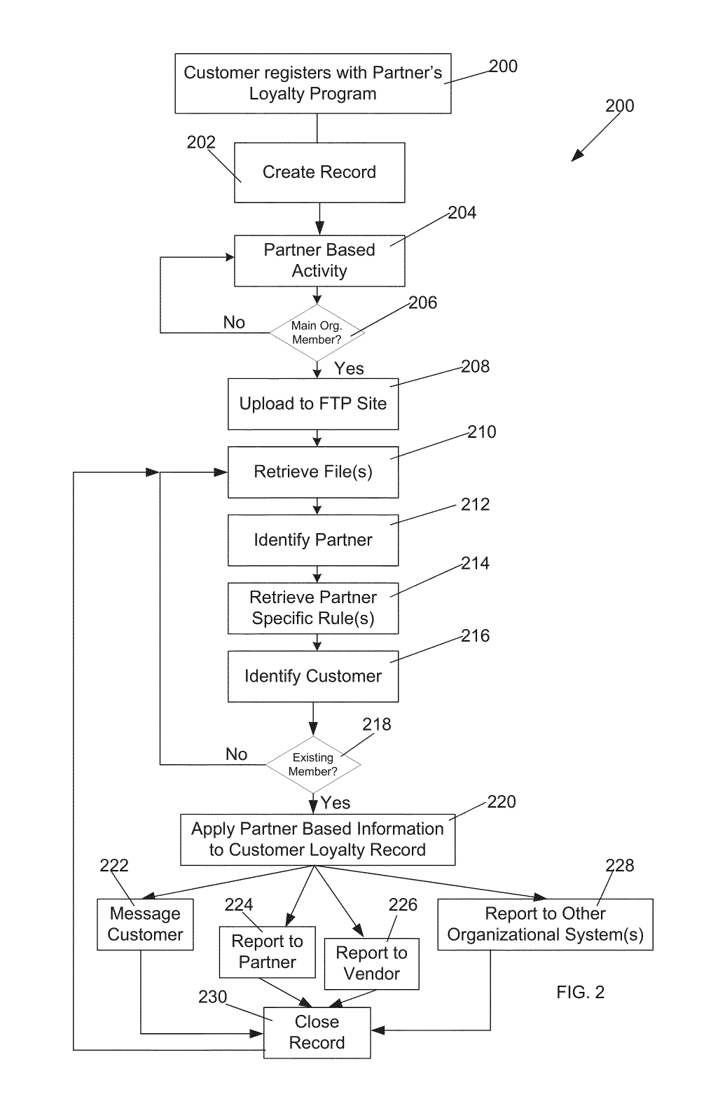

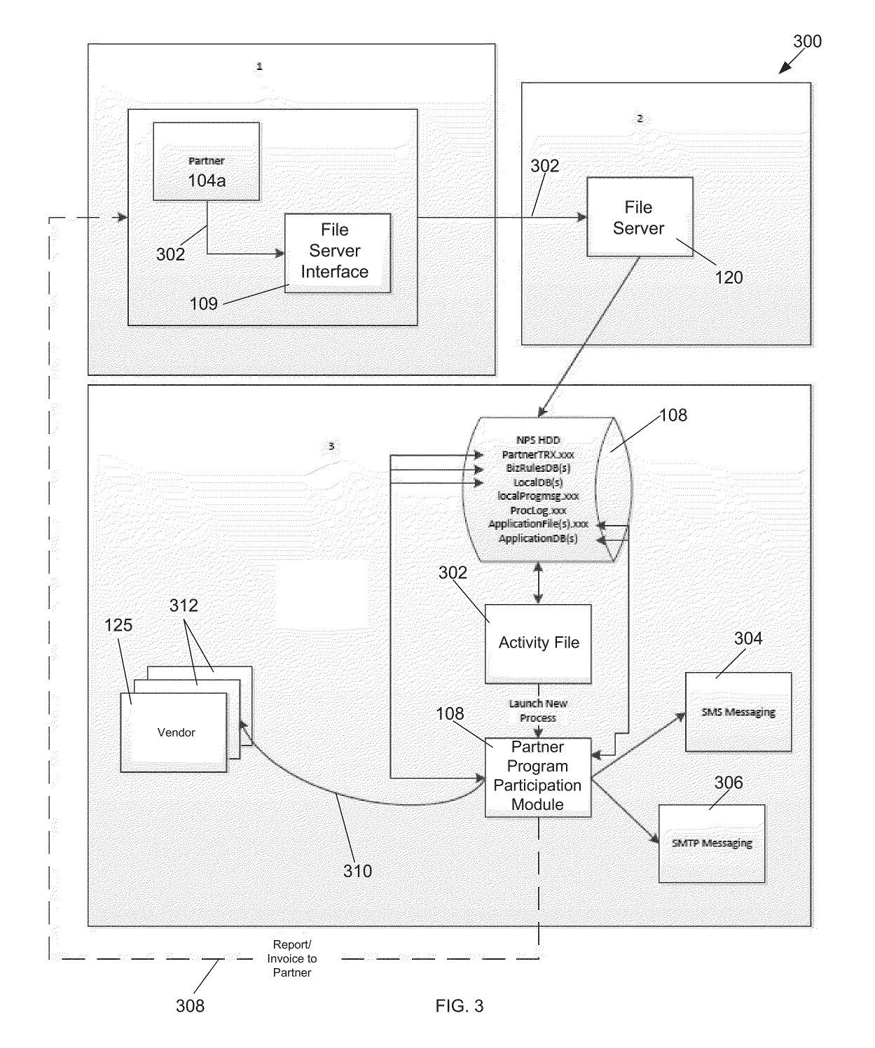

By providing loyalty program activity information from a partner organization to the main organization, the main organization can provide a reward for actions taken outside the main organization (i.e., at the partner organization). This may incentivize a loyalty member of the main organization to perform a qualifying action with a partner organization that they might not otherwise have taken, as they may receive a reward from both the partner and main organizations for the qualifying action. The main organization can monetize the additional business that is driven towards the partner organization as a result of the sharing of loyalty program information and can charge the partner organization for the additional business. Additionally, by analyzing the loyalty program activity information from the partner organization, the main organization can gain valuable marketing insight into partner organizations visited by its loyalty members. Operation of the system 100 for partner program participation in a loyalty marketing program of a main organization 102 is discussed in greater detail below with regard to FIGS. 2 and 3.

FIG. 2 is a flow chart illustrating a process 200 for program participation in a loyalty marketing program of an organization in accordance with at least one embodiment. FIG. 3 is a process flow diagram illustrating operation of a partner program participation system (e.g., the system 100 shown in FIG. 1) in accordance with at least one embodiment described herein. At block 200, a customer registers with a partner organization's (e.g., partner organization 104a shown in FIG. 1) loyalty program. According to one embodiment, the customer registers with the partner organization's loyalty program by filling out a paper application. The information included in the paper application may then be entered into the partner organization's loyalty program module 115 (e.g., by an associate of the partner organization 104a via an interface of the server 114).

According to another embodiment, the customer registers with the partner organization's loyalty program by entering information directly into the loyalty program module 115 via an electronic interface of the server 114 (e.g., via a Graphical User Interface (GUI) displayed on an interface of the server 114, on a mobile device, or on some other computer in communication with the server 114 via the network 106). According to other embodiments, the customer may register with the loyalty program of the partner organization 104a via some other appropriate system or method.

According to one embodiment, while registering with the loyalty program of the partner organization 104a, the customer may indicate whether he/she is also a member of the loyalty program of the main organization 102. In one embodiment, the customer indicates participation in the loyalty program of the main organization 102 by checking a box to indicating enrollment in the main organization's loyalty program and/or entering his/her unique ID or account number associated with the loyalty program of the main organization's loyalty program.

At block 202, based on the information provided by the customer, the loyalty program module 115 of the partner organization 104a generates a loyalty program record in the database 112 associated with the customer. The record may include a record identifier (e.g., an account number associated with the loyalty program of the partner organization 104a), contact information, personal information, preference information, transaction information, other activity based information, or any other type of information which may be utilized by the loyalty program of the partner organization 104a.

While generating a record for the customer in the database 112, the loyalty program module 115 checks to see if the customer has indicated that he/she is a member of the loyalty program of the main organization 102. In response to a determination that the registering customer is a member of the main organization's loyalty program, the loyalty program module 115 may include an indication of participation in the main organization's loyalty program in the record. For example, the record may be flagged as being associated with a customer that is also a member of the main organization's loyalty program and/or may include the unique ID or account number of the customer that is associated with the loyalty program of the main organization.

At block 204, the loyalty program module 115 receives information from another system operated by the partner organization 104a (e.g., a POS system) regarding a qualifying action taken by the customer (e.g., a purchase made by the customer). The loyalty program module 115 may provide a reward (e.g., points, credit, a coupon, etc) to the customer based on the qualifying action taken by the customer. For example, the loyalty program module 115 may update the customer's corresponding loyalty program record in the partner database 112 with reward information or may communicate with another system operated by the partner organization to provide the reward.

At block 206, the loyalty program module determines if the customer who took the qualifying action is also a member of the main organization's loyalty program. The loyalty program module 115 checks the customer's loyalty program record in the partner database 112 to determine if the record was previously flagged as corresponding to a customer that is also a member of the main organization's loyalty program. In response to a determination that the customer is not a member of the main organization's loyalty program, the loyalty program module 115 continues to receive information regarding activity of its members and to provide appropriate rewards.

At block 208, in response to a determination that the customer is a member of the main organization's loyalty program, the loyalty program module 115 of the partner organization 104a generates an activity file 302 summarizing the qualifying action of the customer (e.g., PartnerTRX.xxx) and uploads the activity file 302, via the network interfaces 117 and network 106, to the file server 120 operated by the main organization 102. In one embodiment, the loyalty program module 115 automatically provides the activity file 302 to the file server interface 109 and the file server interface 109 uploads the activity file 302 to the file server 120. In another embodiment, the activity file 302 is manually provided to the file server interface 109 by an associate of the partner organization 104a. For example, in one embodiment, the file server interface 109 provides a Graphical User Interface (GUI) to a system in communication with the server 114 that allows an associate to upload an activity file 302 to the file server interface 109. Upon being uploaded to the file server interface 109, the activity file 302 is uploaded to the file server 120 via the network 106 and the network interfaces 117.

According to one embodiment, the file server interface 109 operated on the server 114 of a partner organization 104a is a File Transfer Protocol (FTP) client that utilizes the FTP to transfer activity files from the partner organization 104a to the main organization. In another embodiment, the file server interface 109 is an Application Programming Interface (API) that allows communication between the loyalty program module 115 and the file server 120. In other embodiments, other protocols and/or methods may be used to transfer information from the partner organization 104a to the main organization 102.

The activity file includes identifying information (e.g., the unique ID/account number associated with the loyalty program of the main organization 102) of the customer and information regarding the qualifying activity (e.g., a transaction) made by the customer. In one embodiment, the activity file uploaded by the loyalty program module 115 to the file server 120 corresponds to a single customer and a single qualifying activity; however, in other embodiments, the activity file uploaded by the loyalty program module 115 to the file server 120 may correspond to any number of customers and/or any number of qualifying actions. In other embodiments, the loyalty program module 115 may upload multiple activity files to the file server 120.

According to one embodiment, the loyalty program module 115 uploads the activity file(s) to the file server 120 at predetermined times. For example, in one embodiment, the loyalty program module 115 uploads the activity file(s) to the file server 120 periodically. In to other embodiments, the loyalty program module 115 may upload the activity file(s) to the file server 120 upon request by the main organization or upon identifying that a customer belonging to both the partner organization's loyalty program and the main organization's loyalty program has performed a qualifying activity. In one embodiment, activity file information may be uploaded to the file server 120 of the main organization 102 in real-time, or near real-time.

At block 210, the partner program participation module 118 retrieves the activity file(s) 302 (e.g., PartnerTRX.xxx), received by the file server 120 from the partner organization 104a, and begins the process of analyzing the information contained in an activity file. In one embodiment, the partner program participation module 118 retrieves the activity file(s) from the file server 120. In another embodiment, the activity file(s) received by the file server 120 are first stored in the database 108 before being retrieved from the database by the partner program participation module 118. In one embodiment, the partner program participation module 118 retrieves the activity file(s) in real time (i.e., as they are received by the file server 120 or database 108; however, in other embodiments, the partner program participation module 118 may retrieve the activity file(s) from the file server 120 or database 108 at predetermined times (e.g., at periodic intervals).

At block 212, the partner program participation module 118 identifies the partner organization 104a that uploaded the activity file to the file server 120. In one embodiment, the partner program participation module 118 identifies the partner organization 104a based on unique partner identification information included in the activity file (e.g., a unique ID); however, in other embodiments, the partner program participation module 118 may identify the partner organization 104a via other known methods (e.g., by network address, email address, etc.)

At block 214, based on the identification of the partner organization 104a at block 212, the partner program participation module 118 retrieves partner specific business rules from a business rules portion of the database 108 (e.g., BizRulesDB(s)). Such partner specific rules include instructions on how the information included in the activity file should be processed. For example, in one embodiment, a partner specific rule defines how a reward should be provided based on activity at the partner organization. In another embodiment, a partner specific rule defines how information in the database 108 should be updated (e.g., with specific retrieve, write, update, and/or flag commands) based on activity at the partner organization. In another embodiment, a partner specific rule defines how interactions with to external parties or vendors should be performed based on activity at the partner organization. In another embodiment, a partner specific rule defines how reports, invoices, and/or confirmation messages should be sent to the partner organization. In other embodiments, the partner specific rules may include any other types of instructions that define how the information included in an activity file, received from a specific partner organization, should be processed.

At block 216, the matching engine 119 of the partner program participation module 118 identifies the customer associated with the received activity file (i.e., the customer who performed the qualifying activity at the partner organization 104a). For example, in one embodiment, the matching engine 119 identifies the customer based on identification information (e.g., a unique ID or account number) included in the activity file. In other embodiments, the matching engine may identify the customer based on some other identification information (e.g., an email address, a network address, etc.) included in the activity file.

At block 218, based on the identification of the customer, the matching engine 119 determines if the customer is a member of the main organization's loyalty program. The matching engine 119 cross references the identification information from the activity file (e.g., the provided unique ID/account number or some other identification information) with existing customer loyalty program records stored in a customer records portion of the main database 108 (e.g., LocalDB(s)) to determine if a corresponding customer loyalty program record already exists for the identified customer. In response to a determination that the customer is not currently a member of the main organization's loyalty program, the partner program participation module 118 dismisses the activity file and continues to retrieve and review additional activity files.

At block 220, in response to a determination that the customer is a member of the main organization's loyalty program, the reward engine 121 of the partner program participation module 118 accesses and updates the existing customer loyalty program record stored in the customer records portion of the database 108 (e.g., LocalDB(s)) based on the activity information included in the activity file and the retrieved partner specific rules. In one embodiment, the reward engine 121 updates the existing customer loyalty program record of the customer to provide the customer with a reward based on the partner organization based activity information included in the activity file. For example, the reward engine 121 may update the loyalty program record of the customer to indicate that a credit with the main organization 102 has been provided to the customer in exchange for a transaction made at the partner organization 104a. In another embodiment, the reward engine 121 inserts the qualifying activity information (e.g., transaction information) into the record of the customer. In other embodiments, the reward engine 121 may edit/update the record of the customer in any appropriate way based on the activity information included in the activity file and the retrieved partner specific rules.

After the loyalty program record of the customer has been updated based on the qualifying action information in the activity file, the partner program participation module 118 may take further action based on the qualifying activity.

In one embodiment, at block 222, upon applying the partner organization based activity information to the customer record, the partner program participation module 118 transmits a message to the customer indicating that his/her record has been updated. For example, in one embodiment, where the reward engine 121 has provided a reward to the customer based on a qualifying action at the partner organization 104a, the partner program participation module 118 transmits a confirmation message to the customer indicating that the reward has been issued. In one embodiment, the partner program participation module 118 transmits a message (e.g., an email) directly to the customer via the network 106. In another embodiment, the partner program participation module 118 communicates with a message service 123 such that the message service 123 transmits a message (e.g., a Short Message Service (SMS) message 304, a Simple Mail Transfer Protocol (SMTP) message 306, or some other type of message) to a device operated by the customer. In other embodiments, the partner program participation module may transmit a message to the customer via any other appropriate method (e.g., via a user interface operated by the customer on a system in communication with the server 110).

In another embodiment, at block 224, upon applying the partner organization based activity information to the customer record, the partner program participation module 118 transmits a report 308 to the partner organization 104a. For example, in one embodiment, where the reward engine 121 has provided a reward to the customer based on a qualifying action at the partner organization 104a, the partner program participation module 118 transmits an invoice to the partner organization 104a indicating that the partner organization 104a owes the main organization 102 a certain amount of money in exchange for driving the customer to take a qualifying action with the partner organization 104a. According to one embodiment, the invoice is transmitted from the partner program participation module 118 to to the partner organization 104 when the loyalty record of the customer is updated with the reward. In another embodiment, the invoice is transmitted from the partner program participation module 118 to the partner organization 104 when the corresponding reward issued to the customer is actually redeemed at the main organization 102 by the customer. In other embodiments, the invoice may be transmitted to the partner organization 104a at other appropriate times.

In other embodiments, any other type of report 308 based on the application of the partner organization based activity to the customer's loyalty record may be generated and sent to the partner organization 104a by the partner program participation module 118. According to one embodiment, the report 308 is transmitted from the partner program participation module to the server 114 of the partner organization 104a via the network 106 and network interfaces 117. In another embodiment, a hard copy of the report (e.g., a printed copy or a copy stored on a computer readable medium) is provided directly to the partner organization 104a. In another embodiment, the report is mailed to the partner organization 104a.

In one embodiment, at block 226, upon applying the partner organization based activity information to the customer record, the partner program participation module 118 provides process control reports 310 to other systems based on the updated customer record. In one embodiment, the partner program participation module 118 communicates with an external vendor 125 based on the updated customer record. For example, in one embodiment, where the main organization 102 is a sports organization, the sports organization may provide a season ticket holder/member with a reward for a qualifying action (e.g., purchase) made with a partner organization 104a (e.g., a retailer, restaurant, or some other type of organization). In one embodiment, the sports organization provides a credit to the season ticket holder/member that is equal to the amount of money spent by the season ticket holder/member at the partner organization. In another embodiment, the sports organization provides a credit to the season ticket holder/member that is a portion, or percentage, of the amount of money spent by the season ticket holder/member at the partner organization.

After the credit is awarded the season ticket holder/member, the partner program participation module 118 transmits a record update request 310 to a ticket management vendor 125 (i.e., a ticket management system operated by the vendor 125) to apply the credit to the season ticket holder's ticket account which is managed by the vendor 125. The vendor 125 receives the credit information from the partner program participation module 118 and updates a record in its database 127 corresponding to the season ticket holder/member (e.g., updates a balance due amount corresponding to the tickets of the member). In other embodiments, the partner program participation module 118 may communicate with any other type of vendor based on the updated customer record.

According to one embodiment, the partner program participation module 118 communicates with an external vendor 125 via the network 106 and the network interfaces 117. In another embodiment, the partner program participation module 118 communicates with the external vendor 125 directly.

In other embodiments, at block 228, the partner program participation module 118 may communicate with, and provide reports to, any other system 312 operated by the main organization 102 based on the updated customer loyalty record. For example, in one embodiment, the partner program participation module 118 communicates with a retail based system (e.g., a POS system, an inventory management system, etc.) operated by the main organization 102 to update the retail based system with information regarding the qualifying action taken by the customer and/or a reward provided to the customer based on the qualifying action.

In another embodiment, the partner program participation module 118 communicates with a season ticket holder/member management system operated by the main organization 102 to update a season ticket holder/member master record with information regarding the qualifying action taken by the customer and/or a reward provided to the customer based on the qualifying action. In another embodiment, the partner program participation module 118 communicates with the loyalty program module 116 operated on the server 110 of the main organization 102 to update the loyalty program module 116 with information regarding the qualifying action taken by the customer and/or a reward provided to the customer based on the qualifying action.

In other embodiments, the partner program participation module 118 may communicate with any other system operated by the main organization 102 to update the system with information regarding the qualifying action taken by the customer and/or a reward provided to the customer based on the qualifying action.

In addition to communicating with other systems operated by the main organization 102, the partner program participation module 118 may also update other information stored in the database 108 based on the qualifying action taken by the customer and/or a reward provided to the customer. For example, the partner program participation module 118 may update files (e.g., ApplicationFile(s).xxx) stored in a portion of the database (e.g., to ApplicationDB(s)) utilized by another application or system of the main organization 102.

According to one embodiment, the partner program participation module 118 also provides, via the network 106, a User Interface (UI) 107 to a display 105 of a system 103 operated by a user 101. The UI 107 displays any qualifying actions corresponding to the user 101 that were reported to the partner program participation module 118 by a partner organization and/or any rewards provided to the user 101 in response to the qualifying actions taken at a partner organization. According to one embodiment, by interacting with the UI 107, the user 101 may redeem a reward awarded in response to a qualifying action taken at a partner organization. For example, in one embodiment, the user 101 may operate the UI 107 to apply a reward (e.g., a credit) to an outstanding balance owed by the user 101 to the main organization 102. In other embodiments, the user may operate the UI 107 to redeem an award for some other benefit (e.g., an item, a discount, etc.). The UI 107 may display qualifying actions and corresponding rewards associated with any number of partner organizations. In one embodiment, the user 101 may operate the UI 107 to redeem rewards corresponding to any number of partner organizations with a single loyalty program or account of the main organization. In another embodiment, the user 101 may redeem rewards corresponding to any number of partner organizations with any number of accounts corresponding to the main organization.

At block 230, once all desired records and systems have been updated with information regarding the qualifying action taken by the customer and/or a reward provided to the customer based on the qualifying action, the partner program participation module 118 operates to close out the activity file. In one embodiment, the partner program participation module 118 flags the activity file as processed and/or deletes the activity file. In another embodiment, the partner program participation module 118 stores the activity file in an archive in the main database 108.

By providing loyalty program activity information from a partner organization to the main organization and automatically matching the activity information to a member of the main organization's loyalty program, the main organization can provide a reward to the customer for actions taken outside the main organization. This may incentivize a loyalty member of the main organization to perform a qualifying action with a partner organization that they might not otherwise have taken, as they may receive a reward from both the partner and main organizations for the qualifying action. The main organization can monetize the additional business that is driven towards the partner organization as a result of the sharing of loyalty program information and can charge the partner organization for the additional to business.

Also, by utilizing identification information provided by a loyalty member at the time of registration to match the loyalty program of the partner organization with the loyalty program of the main organization, the main organization can provide a reward for activity outside the organization without requiring potentially sensitive information to be provided to the partner organization or allowing the partner organization access to potentially sensitive systems of the main organization. In addition, by analyzing the loyalty program activity information from the partner organization, the main organization can gain valuable marketing insight into partner organizations visited by its loyalty members.

Various embodiments according to the present invention may be implemented on one or more computer systems or other devices. A computer system may be a single computer that may include a minicomputer, a mainframe, a server, a personal computer, or combination thereof. The computer system may include any type of system capable of performing remote computing operations (e.g., cell phone, PDA, tablet, smart-phone, set-top box, or other system). A computer system used to run the operation may also include any combination of computer system types that cooperate to accomplish system-level tasks. Multiple computer systems may also be used to run the operation. The computer system also may include input or output devices, displays, or data storage units. It should be appreciated that any computer system or systems may be used, and the invention is not limited to any number, type, or configuration of computer systems. These computer systems may be, for example, computers such as those based on an

Intel processor, Motorola PowerPC, or any other type of processor. It should be appreciated that one or more of any type computer system may be used to partially or fully automate operation of the described system according to various embodiments of the invention. Further, the system may be located on a single computer or may be distributed among a plurality of computers attached by a communications network.

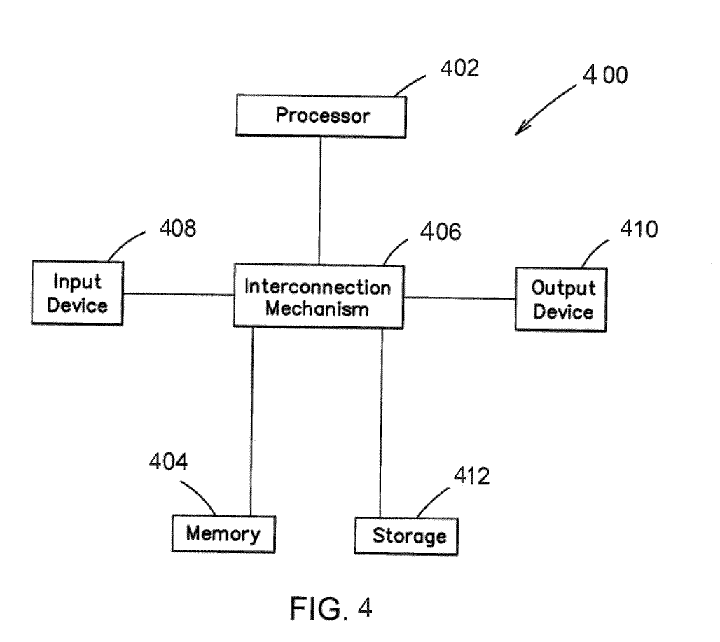

For example, various aspects of the invention may be implemented as specialized software executing in a computer system 400 such as that shown in FIG. 4. The computer system 400 may include a processor 402 connected to one or more memory devices (i.e., data storage) 404, such as a disk drive, memory, or other device for storing data. Memory 404 is typically used for storing programs and data during operation of the computer system 400. Components of computer system 400 may be coupled by an interconnection mechanism 406, which may include one or more busses (e.g., between components that are integrated within a same machine) and/or a network (e.g., between components that reside on separate discrete machines). The interconnection mechanism 406 enables communications (e.g., data, instructions) to be exchanged between system components of system 400. Computer system 400 also includes one or more input devices 408, for example, a keyboard, mouse, trackball, microphone, touch screen, and one or more output devices 410, for example, a printing device, display screen, and/or speaker. In addition, computer system 400 may contain one or more interfaces that connect computer system 400 to a communication network (in addition or as an alternative to the interconnection mechanism 406).

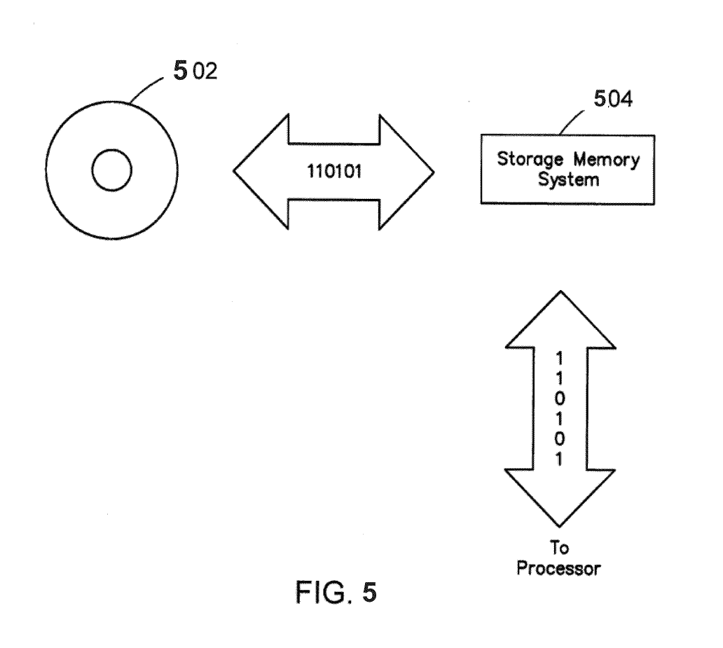

The storage system 412, shown in greater detail in FIG. 5, typically includes a computer readable and writeable nonvolatile recording medium 502 in which signals are stored that define a program to be executed by the processor or information stored on or in the medium 502 to be processed by the program. The medium may, for example, be a disk or flash memory. Typically, in operation, the processor causes data to be read from the nonvolatile recording medium 502 into another memory 504 that allows for faster access to the information by the processor than does the medium 502. This memory 504 is typically a volatile, random access memory such as a dynamic random access memory (DRAM) or static memory (SRAM). It may be located in storage system 412, as shown, or in memory system 404. The processor 402 generally manipulates the data within the integrated circuit memory 404, 504 and then copies the data to the medium 502 after processing is completed. A variety of mechanisms are known for managing data movement between the medium 502 and the integrated circuit memory element 404, 504, and the invention is not limited thereto. The invention is not limited to a particular memory system 404 or storage system 412.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects of the invention may be practiced, it should be appreciated that aspects of the invention are not limited to being implemented on the computer system as shown in FIG. 4. Various aspects of the invention may be practiced on one or more computers having a different architecture or components than that shown in FIG. 4.

Computer system 400 may be programmable using a high-level computer to programming language. Computer system 400 may be also a specially-designed computer implemented using specially programmed, special purpose hardware. In computer system 400, processor 402 is typically a commercially available processor such as the well-known Pentium class processor available from the Intel Corporation. Many other processors are available. Such a processor usually executes an operating system which may be, for example, the Windows 7, or Windows 8 operating systems available from the Microsoft Corporation, MAC OS System X operating system or an iOS operating system available from Apple Computer, one of many Linux-based operating system distributions, for example, the Enterprise Linus operating system available from Red Hat Inc., or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol. Various embodiments of the present invention may be programmed using an object-oriented programming language, such as Java, C++, or C# (C-Sharp). Other object-oriented programming languages may also be used. Alternatively, functional, scripting, and/or logical programming languages may be used. Various aspects of the invention may be implemented to in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

As discussed above, activity files including information regarding the qualifying actions of customers at a partner organization are uploaded to a file server 120 of the main organization 120 via a network 106; however, in other embodiments, the activity files may be provided directly to the server 110 of the main organization via a computer readable medium (e.g., flash drive, compact disk, etc.).

As discussed above, the main organization is in communication with three partner organizations (104a-c); however, in other embodiments, the main organization may be in communication with, and receive activity files from, any number of partner organizations. As also discussed above, the main organization is a sports organization (e.g., a professional sports team); however, in other embodiments, the main organization may be any other type of organization having a loyalty program.

As discussed above, the partner program participation module of a main organization provides a reward to a loyalty program member of the main organization based on qualifying activity information included in an activity file received from a single partner organization. However, in other embodiments, the partner program participation module of a main organization may provide a reward to a loyalty program member of the main organization based on multiple activity files (regarding multiple qualifying actions) received from multiple partner organizations. For example, the partner program participation module may provide a single reward (e.g., a 15% discount) to a loyalty program member of the main organization based on a first qualifying action taken by the loyalty program member at a first partner organization (e.g., a first purchase with a 5% discount offered by the loyalty program of the first partner organization), a second qualifying action taken by the loyalty program member at a second partner organization (e.g., a second purchase with a 5% discount offered by the loyalty program of the second partner organization), and a third qualifying action taken by the loyalty program member at a third partner organization (e.g., a third purchase with a 5% discount offered by the loyalty program of the third partner organization).

As discussed above, the main organization operates a single database 108; however, in other embodiments, the main organization may operate any number of different databases. For example, the main organization may operate a business rules database, a local database, an activity file database, an application database, a loyalty program database, or any other appropriate type of database.

As discussed above, the main organization operates a main server and a file server; however, in other embodiments, the main organization may operate any number of servers and each server can operate any of the modules/engines discussed above.

Embodiments described herein provide a system and method for partner program participation in a loyalty program of a main organization. By providing loyalty program activity information from a partner organization to the main organization and automatically matching the activity information to a member of the main organization's loyalty program, the main organization can provide a reward to the customer for actions taken outside the main organization. This may incentivize a loyalty member of the main organization to perform a qualifying action with a partner organization that they might not otherwise have taken, as they may receive a reward from both the partner and main organizations for the qualifying action. The main organization can monetize the additional business that is driven towards the partner organization by invoicing the partner organization based on rewards awarded in the main organization for the qualifying action at the partner organization.

Also, by utilizing the “one-way” transfer of information (i.e., only the transfer of information from the partner organization to the main organization (e.g., via an FTP client) to receive information regarding a qualifying action of a customer and match the qualifying action of the customer to the loyalty program of the main organization, the transfer of potentially sensitive information from the main organization to the partner organization can be avoided and access to the private network and systems of the main organization by the partner organization can be limited. In addition, by analyzing the loyalty program activity information from the partner organization, the main organization can gain valuable marketing insight into partner organizations visited by its loyalty members.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for partner program participation in a first loyalty program of an organization, the system comprising:
a network interface configured to be coupled to a communication network;
a database configured to store a plurality of customer records associated with the first loyalty program of the organization; and
a partner program participation module coupled to the network interface and the database and configured to communicate with a server of a partner organization via the network interface and the communication network,
wherein the partner program participation module is further configured to:
receive an activity file from the server of the partner organization, the activity file including information related to a qualifying action taken by a customer with respect to a second loyalty program of the partner organization; and
update, in the database, a first customer record associated with the first loyalty program of the organization based on the information included in the activity file related to the qualifying action taken by the customer with respect to the second loyalty program of the partner organization.

2. The system of claim 1, further comprising a file server coupled to the partner program participation module and the network interface and configured to receive the activity file from the server of the partner organization and provide the activity file to the partner program participation module.

3. The system of claim 2, wherein the file server utilizes the File Transfer Protocol to communicate with the server of the partner organization

4. The system of claim 1, wherein the partner program participation module comprises a matching engine coupled to the database, wherein the matching engine is configured to cross-reference the information in the activity file with the plurality of customer records stored in the database to identify the first customer record.

5. The system of claim 1, wherein the partner program participation module comprises a reward engine coupled to the database, wherein the reward engine is configured to update, in the database, the first customer record associated with the first loyalty program of the organization based on the information included in the activity file.

6. The system of claim 5, wherein the reward engine is further configured to update the first customer record with a reward based on the information included in the activity file related to the qualifying action taken by the customer with respect to the second loyalty program of the partner organization.

7. The system of claim 6, wherein the partner program participation module is to further configured to communicate with an external vendor via the communication network and transmit a record update request to the vendor based on the reward.

8. The system of claim 5, wherein the reward engine is further configured to insert the information included in the activity file into the first customer record.

9. The system of claim 5, wherein the partner program participation module is further configured to transmit a report back to the partner organization in response to the reward engine updating the first customer record.

10. The system of claim 9, wherein the report is one of a confirmation message and an invoice.

11. The system of claim 9, wherein the partner program participation module is further configured to transmit the report via an external messaging service.

12. The system of claim 1, wherein the partner program participation module is further configured to:
identify the partner organization based on information included in the activity file;
retrieve, from the database, at least one business rule specific to the partner organization; and
update the first customer record based on the at least one business rule.

13. The system of claim 1, wherein the organization is a sports organization,
wherein the first loyalty program of the sports organization is a season ticket member program, and
wherein the partner program participation module is further configured to update the first customer record associated with the season ticket member program with a credit based on the information included in the activity file.

14. The system of claim 13, wherein the partner program participation module is further configured to communicate with an external ticket management system via the communication network and transmit a record update request to the external ticket management system based on the credit.

15. A method for providing partner program participation in a first loyalty program of an organization, the method comprising:
receiving, with a partner program participation module operated on a server of the organization, an activity file from a loyalty program module operated on a server of a partner organization, the activity file including information related to a qualifying action taken by a customer with respect to a second loyalty program of the partner organization; and
updating in a database of the organization, with the partner program participation module, a first customer record associated with the first loyalty program of the organization based on the information included in the activity file related to the qualifying action taken by the customer with respect to the second loyalty program of the partner organization.

16. The method of claim 15, further comprising generating, with the loyalty program module operated on the server of the partner organization, the activity file based on the qualifying action taken by the customer with respect to the second loyalty program of the partner organization.

17. The method of claim 16, further comprising:
determining, with the loyalty program module, whether the customer is also a member of the first loyalty program of the organization; and
in response to a determination that the customer is also a member of the first loyalty program of the organization, providing the activity file to the partner program participation module operated on the server of the organization.

18. The method of claim 17, wherein determining comprises referencing a loyalty program record in a database of the partner organization to determine if the record includes an indication of participation in the first loyalty program of the organization.

19. The method of claim 16, further comprising cross-referencing, with a matching engine operated by the partner program participation module, information included in the activity file with a plurality of customer loyalty program records stored in the database of the organization to identify the first customer record.

20. The method of claim 19, wherein generating the activity file comprises including a unique identifier associated with the first loyalty program of the organization in the activity file and cross-referencing includes matching the unique identifier in the activity file with the plurality of customer loyalty program records stored in the database of the organization to identify the first customer record.

21. The method of claim 15, wherein updating comprises updating the first customer record to include a reward based on the information included in the activity file related to the qualifying action taken by the customer with respect to the second loyalty program of the partner organization.

22. The method of claim 21, further comprising providing a record update request to an external vendor based on the reward.

23. The method of claim 15, further comprising providing, with the partner program participation module, a report back to the partner organization in response to updating the first customer record.

24. The method of claim 23, wherein providing a report back to the partner organization comprises one of providing an invoice to the partner organization and providing a confirmation message to the partner organization.

25. The method of claim 15, further comprising:
identifying the partner organization based on information included in the activity file; and
retrieving, from the database of the organization, at least one business rule specific to the partner organization,
wherein updating the first customer record includes updating the first customer record based on the at least one business rule.

26. The method of claim 15, wherein the organization is a sports organization and the first loyalty program of the sports organization is a season ticket member program,
wherein updating includes updating the first customer record associate with the season ticket member program with a credit based on the information included in the activity file.

27. The method of claim 26, further comprising transmitting a record update request to an external ticket management system based on the credit.

28. A non-transitory computer-readable medium encoded with instructions for execution on a distributed computer system of an organization, the instructions when executed, performing a method comprising acts of:
receiving, with a partner program participation module operated on a server of the organization, an activity file from a loyalty program module operated on a server of a partner organization, the activity file including information related to a qualifying action taken by a customer with respect to a second loyalty program of the partner organization; and
updating in a database of the organization, with the partner program participation module, a first customer record associated with the first loyalty program of the organization based on the information included in the activity file related to the qualifying action taken by the customer with respect to the second loyalty program of the partner organization.
